(19) United States
(12) Patent Application Publication
(10) Pub. No.: US 2009/0161581 A1
(43) Pub. Date: Jun. 25, 2009

(54) ADDRESS AUTOCONFIGURATION METHOD AND SYSTEM FOR IPv6-BASED LOW-POWER WIRELESS PERSONAL AREA NETWORK

(76) Inventor: Jin Hyoung KIM, Hwaseong-si (KR)

Correspondence Address: CHA & REITER, LLC, 210 ROUTE 4 EAST STE 103, PARAMUS, NJ, 07652, US

(21) Appl. No.: 12/335,608

(22) Filed: Dec. 16, 2008

(30) Foreign Application Priority Data
Dec. 20, 2007 (KR) 2007-0134600

(51) Int. Cl. H04L 12/28

(52) U.S. Cl. 370/254

(57) ABSTRACT

An IP address autoconfiguration method and system of an IPv6-based Low Power WPAN for reducing network traffics is applicable for an Internet Protocol (IP) based network including a plurality of devices. The address autoconfiguration method generates and broadcasts, at a first device, a beacon frame containing an adaptive router advertisement (RA) message having prefix information, and configures, at a second device received the beacon frame, an IP address using the prefix information extracted from the adaptive RA message carried by the beacon frame and a physical address of the second device. The system includes a first type device which broadcasts a beacon frame carrying a prefix; at least one second type device which relays the prefix using a beacon frame; and at least one terminal device which configures an IP address using the prefix in the beacon frame and a physical address of the terminal device.

### CLAIM OF PRIORITY

This application claims the benefit of priority under 35 U.S.C. § 119(a) of a Korean patent application filed in the Korean Intellectual Property Office on Dec. 20, 2007 and assigned Serial No. 2007-0134600, the entire disclosure of which is hereby incorporated by reference in its entirety.

### BACKGROUND OF THE INVENTION

1. Field of the Invention

The present invention relates to an Internet Protocol version 6 (IPv6) based Low Power Wireless Personal Area Network (WPAN) and, in particular, to an IP address autoconfiguration method and system for an IPv6 based Low Power WPAN.

2. Description of the Related Art

The recent advances in wireless Internet access technologies and international technology standardization efforts have enabled the development of low cost multifunctional sensor nodes, whereby wireless sensor networks are applied in various industrial and commercial environments. For example, wireless Sensor Networks, which are basic infrastructures of ubiquitous computing, are composed of a plurality of low weight-low power-sensor nodes. Since the battery-powered sensor nodes are limited in operation time and computing power, the wireless sensor network is dynamically changed in topology due to the frequent entry and exit of the sensor nodes from the network.

A wireless sensor network processes the data collected by the sensor nodes and provides users with a variety of useful information that is convenient for both life and scientific applications.

Several standards are currently either ratified or under development for wireless sensor networks. Among them, for example, IEEE 802.15.4 standard specifies Medium Access Control (MAC) and Physical (PHY) layers of a Low Rate WPAN (LR-WPAN) focusing on low-cost, low-speed, and relatively short range communication.

In the meantime, IPv6 based Low Power WPAN (hereinafter called “6LoWPAN”) is a promising standard optimizing IPv6 for use with low-power, low-bandwidth communication technologies such as the IEEE 802.15.4 radio. Over the WPAN, the 6LoWPAN implements IP and TCP/UDP-based networking with characteristics such as power conservative routing, low overhead, routing table, and scalability. Typically, the 6LoWPAN is implemented with devices operating in association with physical connection to the application environment in real world, i.e. the sensor nodes operating on the basis of the IEEE 802.15.4 standard. The 6LoWPAN is currently under development by the working group in the internet area of Internet Engineering Task Force (IETF).

In the 6LoWPAN, each node uses a Stateless Address Autoconfiguration to get its IPv6 address. The Stateless Address Autoconfiguration is an address configuration function corresponding to Dynamic Host Configuration Protocol (DHCP). Unlike DHCP, the Stateless Address Autoconfiguration does not require the reservation of IP addresses.

The address configuration is performed, for example, by adding a node physical address to a prefix carried by a Router Advertisement (RA) message broadcasted by a PAN coordinator. The physical address is the MAC address of the sensor node. The RA message can be received in two ways: first, a Reduced Function Device (RFD) can send, when it boots up, a Router Solicitation (RS) message and receives a (RA) message from a Full Function Device (FFD) as the PAN coordinator in response to the RS message; and second, the RFD can receive the RA message that is periodically transmitted by the PAN coordinator.

An explanation of the way the RA message for the address Autoconfiguration in 6LoWPAN will now be described. FIG. 1 is a diagram illustrating a conventional prefix acquisition process in a 6LoWPAN network.

Still referring to FIG. 1, it is assumed that the nodes 1 to 4 are full function devices (FFDs), and devices 5 and 6 are reduced function devices (RFDs). Among the FFDs 1 to 4, the FFD 1 is a PAN coordinator, the FFDs 2 to 4 are link coordinators. It is assumed that only the link coordinator 2 is located in a radio coverage of the PAN coordinator 1.

First, the pan coordinator 1 broadcasts an RA message. As previously discussed herein above, the wireless nodes in FIG. 1 operate on the basis of IEEE 802.15.4 standard. Since the IEEE 802.15.4 standard does not support multicast (which is well-known in the art), the PAN coordinator 1 maps an IPv6 multicast address to an IEEE 802.15.4 broadcast address. In other words, the PAN coordinator broadcasts the RA message mapped to the IPv6 address. The link coordinator 2 located in the radio coverage of the PAN coordinator 1 receives the RA message and broadcasts the RA message again. Also, the other coordinators 3 and 4 located in the radio coverage of the coordinator 2 receive and broadcast the RA message. Accordingly, the broadcast message propagates over the entire network to increase network traffic exponentially, resulting in traffic flooding. In a similar manner, the Router Solicitation (RS) messages transmitted by the RFDs are likely to cause traffic flooding, too.

### SUMMARY OF THE INVENTION

The present invention provides an IP address autoconfiguration method and system for an IPv6 based Low Power WPAN for avoiding traffic flooding. Also, the present invention provides an IP address Autoconfiguration method and system for an IPv6 based Low Power WPAN for reducing network traffic and increasing network throughput.

In accordance with an exemplary embodiment of the present invention, an address autoconfiguration method for an Internet Protocol (IP) based network including a plurality of devices may include generating, at a first device, a beacon frame containing an adaptive router advertisement (RA) message having prefix information; broadcasting the beacon frame; and configuring, at a second device received the beacon frame, an IP address using the prefix information extracted from the adaptive RA message carried by the beacon frame and a physical address of the second device.

The address autoconfiguration method may further include transmitting, at the second device, a beacon frame carrying the adaptive RA message and configuring, at a third device received the beacon frame, an IP address using the prefix information extracted from the adaptive RA message carried by the beacon frame and a physical address of the third device.

According to an exemplary aspect of the present invention, the adaptive RA message may comprise an RA message and the prefix information.

According to another exemplary aspect of the present invention, the first and second devices can be full function devices having routing function, and the third device can be a reduced function device having no routing function.

According to another exemplary aspect of the present invention, the first device may comprise a network coordinator and the second device may comprise a link coordinator.

According to another exemplary aspect of the present invention, the address autoconfiguration method may further include transmitting, at the second device, a beacon frame carrying the adaptive RA message; extracting, at a third device received the beacon frame, the prefix information from the adaptive RA message carried by the beacon frame; and configuring an IP address of the third device using the prefix information and a physical address of the third device.

In accordance with another exemplary embodiment of the present invention, an address autoconfiguration system for an Internet Protocol (IP) based network including a plurality of devices may include a first type device which broadcasts a beacon frame carrying a prefix; at least one second type device which relays the prefix using a beacon frame; and at least one terminal device which configures an IP address using the prefix carried by the beacon frame and a physical address of the terminal device.

According to an exemplary aspect of the present invention, the at least one second type device configures an IP address using the prefix and a physical address of the second type device.

According to an exemplary aspect of the present invention, each device includes a network layer for routing an adaptive router advertisement (RA) message containing a prefix; an adaptation layer for generating a beacon payload containing the adaptive RA message; and a media access control layer for generating a beacon frame containing the beacon payload to be transmitted and extracting the beacon payload from a received beacon frame.

According to an exemplary aspect of the present invention, the MAC layer extracts the beacon payload from the received beacon frame and delivers the beacon payload to the adaptation layer.

Preferably, the adaptation layer may extract the adaptive RA message from the beacon payload and extracts an RA message and the prefix.

Preferably, the adaptation layer can include an RA message generator for generating the adaptive RA message; a beacon payload controller for generating the beacon payload containing the adaptive RA message and delivering the beacon payload to the media access control layer; an RA message parser for extracting an RA message and prefix from a beacon payload received from the media access control layer; and an RS message parser for receiving a router solicitation (RS) message from the media access control layer and outputting the RA message and prefix corresponding to the RS message to the RA message generator.

Preferably, the first and second type devices ma comprise full function devices, and the at least one terminal device may comprise a reduced function device.

Preferably, the first type device comprises a network coordinator, and the at least one second type device comprises a link coordinator.

### BRIEF DESCRIPTION OF THE DRAWINGS

The above and other exemplary aspects, features and advantages of certain exemplary embodiments of the present invention, which have been presented herein for illustrative purposes only, will become more apparent from the following description taken in conjunction with the accompanying drawing, in which:

FIG. 1 is a diagram illustrating a conventional prefix acquisition process in a 6LoWPAN network;

FIG. 2A is a schematic diagram illustrating a 6LoWPAN system according to an exemplary embodiment of the present invention;

FIGS. 2B-2E are tables showing various formats and prefix information according to respective exemplary embodiments according to the present invention;

FIG. 3 is a diagram illustrating protocol stack configurations of components of the 6LoWPAN system of FIG. 2;

FIG. 4 is a diagram illustrating a protocol stack embedded in a device of a 6LoWPAN according to an exemplary embodiment of the present invention;

FIG. 5 is a schematic diagram illustrating a network topology of a 6LoWPAN according to an exemplary embodiment of the present invention;

FIG. 6 is a message flow diagram illustrating an address autoconfiguration method for the 6LoWPAN of FIG. 5 according to an exemplary embodiment of the present invention; and

FIG. 7 is a message flow diagram illustrating an address autoconfiguration method for the 6LoWPAN of FIG. 5 according to another exemplary embodiment of the present invention.

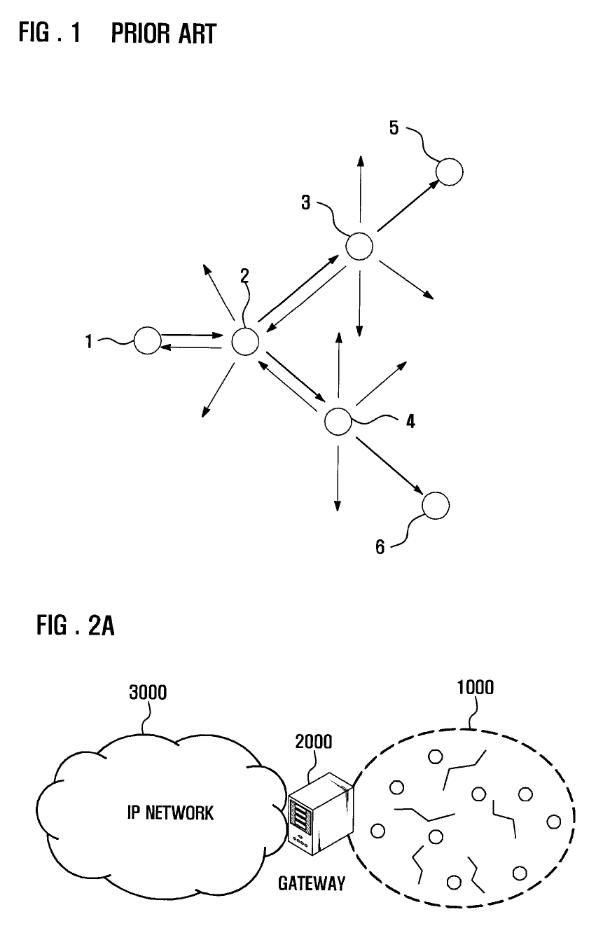

### DETAILED DESCRIPTION

Certain exemplary embodiments of the present invention are provided herein only for illustrative purposes, and are described with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

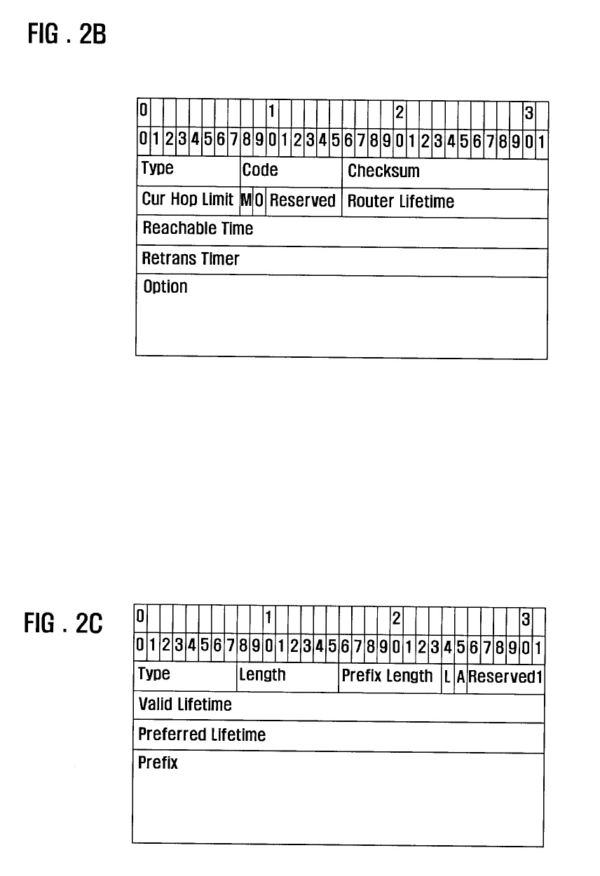

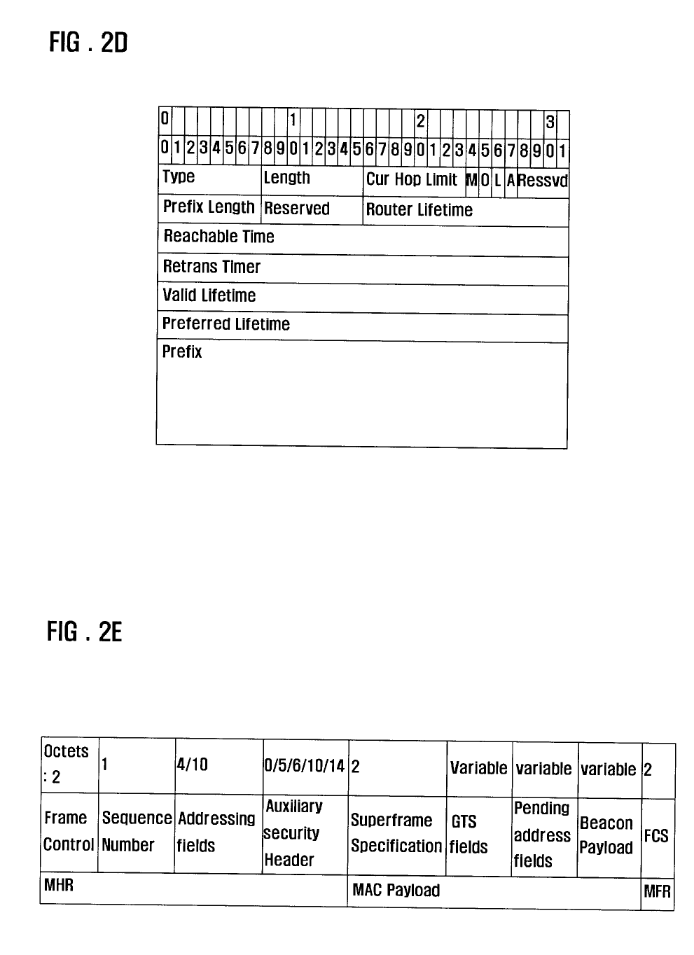

In the following description, the address autoconfiguration method and system of the present invention is described in association with 6LoWPAN. FIG. 2 is a schematic diagram illustrating 6LoWPAN system according to an exemplary embodiment of the present invention, and FIG. 3 is a diagram illustrating exemplary protocol stack configurations of components of the 6LoWPAN system of FIG. 2A.

Referring now to FIGS. 2A and 3, the 6LoWPAN system includes a 6LoWPAN 1000, a gateway 2000, and an IP network 3000. The 6LoWPAN 1000 is connected to the IP network 3000 via the gateway 2000. The 6LoWPAN 1000 sends the data collected by devices, i.e. sensor nodes, to a user through the IP network 3000.

In order to use the IPv6 over the IEEE 802.15.4 network, there are some problems that are addressed by the present invention. One of the problems has to do with a limited packet size. That is, the Packet Data Unit (PDU) of the IEEE 802.15.4 network is 127 bytes, whereas the IPv6 Maximum Transmission Unit (MTU) is 1280 bytes. In order to solve this problem, the 6LoWPAN 1000 is provided with an Adaptation layer introduced between MAC and Network layers to enable efficient transmission of IPv6 data grams over 802.15.4 links.

The adaptation layer is preferably provided with a header compression scheme to fragment the IPv6 packet and reassemble the fragments. Also, the adaptation layer is preferably responsible for UDP/TCP/ICMPv6 header compression Mesh routing, and Stateless Address Autoconfiguration for configuring IPv6 address using 16 bits of IEEE 802.15.4 address.

Still referring to FIGS. 2A and 3, the gateway 2000 runs two protocol stacks corresponding to the protocol stacks of the devices of the 6LoWPAN 1000 and host devices of the IP network 3000.

Structures and functions of a device of the 6LoWPAN 1000 are described hereinafter. Each device operates with a protocol stack having the aforementioned adaptation layer. In this exemplary embodiment, the devices are classified into full-function devices (FFDs) and Reduced Function Device RFDs, and the FFDs are classified into a PAN coordinator and link coordinators.

The devices comprise wireless communication nodes operating, for example, with IEEE 802.15.4 radio interface and protocol stack. The devices are preferably implemented with sensor nodes. A sensor node can be provided with a sensor for sensing to collect specific data, and may include, for example, an Analog to Digital Converter (ADC), a processor and memory for processing the collected data, a battery as a power source, and a transceiver for transmitting and receiving data.

The FFD is implemented with a routing function, but an RFD is not. That is, the FFD can relay a message, but the RFD cannot relay a message.

The FFDs are typically composed of a signal PAN coordinator and a plurality of link coordinators. The PAN coordinator manages the personal area network (PAN) to which it belongs and transmits an IPv6 prefix. In this exemplary embodiment, the PAN coordinator is an IEEE 802.15.4 standard-based network coordinator. However, a person of ordinary skill in the art understands and appreciates that the present invention is applicable to other networks, or future variations based in whole or in part on IEE 802.15.4 or a subsequent version of IP that is currently IPv6.

The IPv6 prefix is used for address autoconfiguration. The IPv6 prefix is contained in an adaptive Router Advertisement (RA) message which is broadcasted in the form of a beacon frame. The adaptive RA message is formed by modifying the conventional RA message. Accordingly, each device receiving the beacon frame can obtain the IPv6 prefix from the RA message carried by the beacon frame. The device obtaining the IPv6 prefix forms an IP address using the prefix and its own MAC address. Also, the FFDs broadcast their beacon frames containing the prefix such that all the devices received the prefix can configure their global addresses automatically. The devices are configured to broadcast the beacon frame at their respective beacon frame transmission times such that it is possible to avoiding traffic flooding.

The adaptive RA message formed by modifying the conventional RA message is described hereinafter. FIGS. 2B and 2C show an RA message format and prefix information format according to this exemplary embodiment, respectively.

As shown in FIG. 2B, the RA message includes a type field, a length field, a cur hop limit field, an M flag field, an O flag field, a reachable timer field, a retrans timer field, and an option field.

As shown in FIG. 2C, the prefix information includes a type field, a length field, a prefix length field, an L flag field, an A flag field, a valid lifetime field, a preferred lifetime field, and a prefix field.

In this exemplary embodiment, the prefix information of FIG. 2C is contained in the option field of the RA message of FIG. 2A, and this RA message is called as adaptive RA message.

FIG. 2D shows the adaptive RA message format according to this exemplary embodiment.

As shown in FIG. 2D, the adaptive RA message includes a type field, a length field, a cur hop limit field, an M flag field, an O flag field, and L flag field, an A flag field, a prefix length field, a router lifetime field, a valid lifetime field, a preferred lifetime field, and a prefix field.

The adaptive RA message carried by the beacon frame. FIG. 2E shows a beacon frame format according to this exemplary embodiment.

The beacon frame includes a MAC payload field for carrying data that is defined by a MAC header (MHR) and a MAC footer (MFR) field. That is, the MAC frame is composed of a MAC header (MHR), a MAC payload, and a MAC footer (MFR).

The MAC header includes a frame control field, a beacon sequence number (BSN) field, and an addressing field. The MAC header may further include an auxiliary security header. In addition, the MAC payload is composed of a superframe specification field, a guaranteed time slot (GTS) field, a pending address field, and a beacon payload field.

The MAC footer includes a 16-bit frame check sequence (FCS).

As aforementioned, the adaptive RA message formatted as shown in FIG. 2D is carried in the beacon payload field of the beacon frame.

Heretofore, the structures of the RA message, adaptive RA message, and beacon frame have been described.

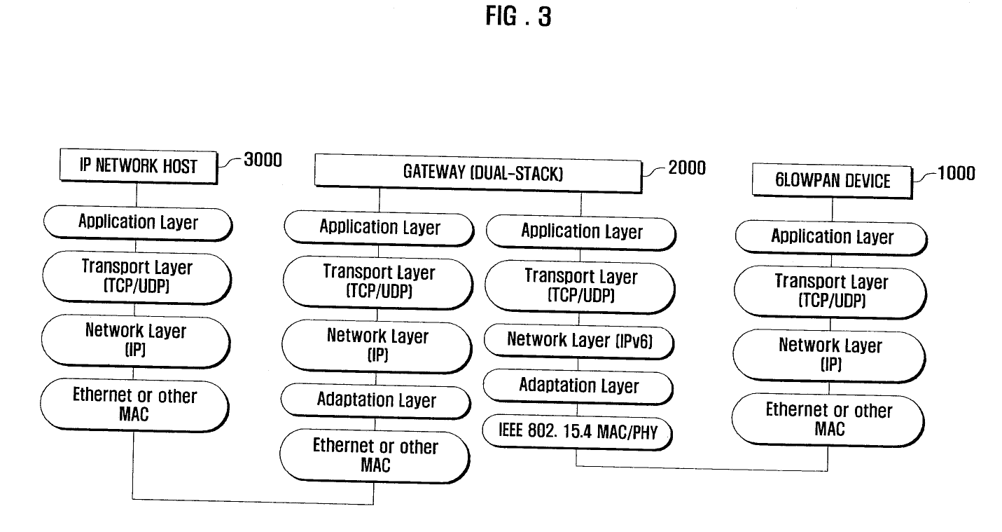

In this exemplary embodiment, the devices generate and exchange the above-described messages or frames. The adaptation layer enables the devices to generate and transmit the above structured adaptive RA message. The operation of the device in terms of its protocol stack is described hereinafter in more detail. FIG. 4 is a diagram illustrating such a protocol stack embedded in a device of a 6LoWPAN according to an exemplary embodiment of the present invention.

Referring now to FIG. 4, the 6LoWPAN protocol stack includes a Network Layer 100, an Adaptation Layer 200, and a MAC layer 300. Also, the 6LoWPAN protocol includes a Physical Layer below the MAC Layer 300, and a Transport Layer and an Application Layer sequentially arranged on the Network Layer 100. In order to focus on the subject matter of the present invention, detailed descriptions of the structures and functions of the Physical (PHY) Layer, Transport Layer, and Application Layer are omitted.

In this exemplary embodiment, the transport layer supports Transmission Control Protocol (TCP), User Datagram Protocol (UDP), and Internet Control Message Protocol (ICMP). The Network layer 100 supports the IPv6 protocol, and the MAC layer 300 and PHY layer support the protocols specified in the IEEE 802.15.4 standard.

The adaptation layer 200 is provided with a plurality of entities including a mesh routing entity 210, a header compression entity 220, a fragmentation entity 230, and a proxy entity 240. The mesh routing entity 210 is responsible for mesh routing of the 6LoWPAN using the M and O flags.

The header compression entity 220 is responsible for compressing headers of network transport layer protocols' data unit headers. That is, the header compression entity 220 can compress the IPv6 header and UDP/TCP/ICMPv6 headers. Particularly, the IPv6 header can be compressed except for its hop limit field (8 bits). The fragmentation entity 230 is responsible for fragmentation and reassembly of the IPv6 MTUs such that the IPv6 MTUs are carried by IEEE 802.15.4 PDUs. The fragmentation entity 230 checks whether the IPv6 datagram can be carried by a single IEEE 802.15.4 frame and uses different header formats according to whether the IPv6 datagram can be arranged within a single IEEE 802.15.4 frame.

The proxy entity 240 includes an RS message parser 241, a RA message parser 243, a beacon payload controller part 245, and a RA message generator 247.

The RS message parser 241 receives a RS message from the network layer 100 and requests the RA message generator 247 generate an RA message.

The RA message parser 243 receives an RA message from the network layer 100, generates an adaptive RA message (see FIG. 2D), and sends the adaptive RA message to the beacon payload controller 245.

The beacon payload controller 245 inserts the adaptive RA message into the beacon payload field of the beacon frame. In other words, the beacon payload controller 245 generates a beacon payload using the adaptive RA message.

After receiving a beacon frame from outside, the beacon payload controller 245 extracts the adaptive RA message from the received beacon frame and delivers the adaptive RA message to the RA message generator 247 so as to generate a relay RA message.

As shown in FIG. 2E, the beacon frame includes a beacon payload which as equation: aMaxBeaconPayloadLength=aMaxPHYPacketSize−aMaxBeaconOverhead. Accordingly, the length of a beacon payload (aMaxBeaconPayloadLength) becomes 57 bytes (127-75). Also, the beacon payload is generated using a macBeaconPayloadAttribute and is preferably extracted using a NOTIFY.IndicationPayloadLength.

The RA message generator 247 receives the adaptive RA message extracted from the beacon payload field of the received beacon frame and generates an RA message. The RA message is delivered to the network layer 100 via the mesh routing entity 210.

The address autoconfiguration method of a 6LoWPAN device is described hereinafter. In this exemplary embodiment, the beacon frame is used to deliver the adaptive RA message.

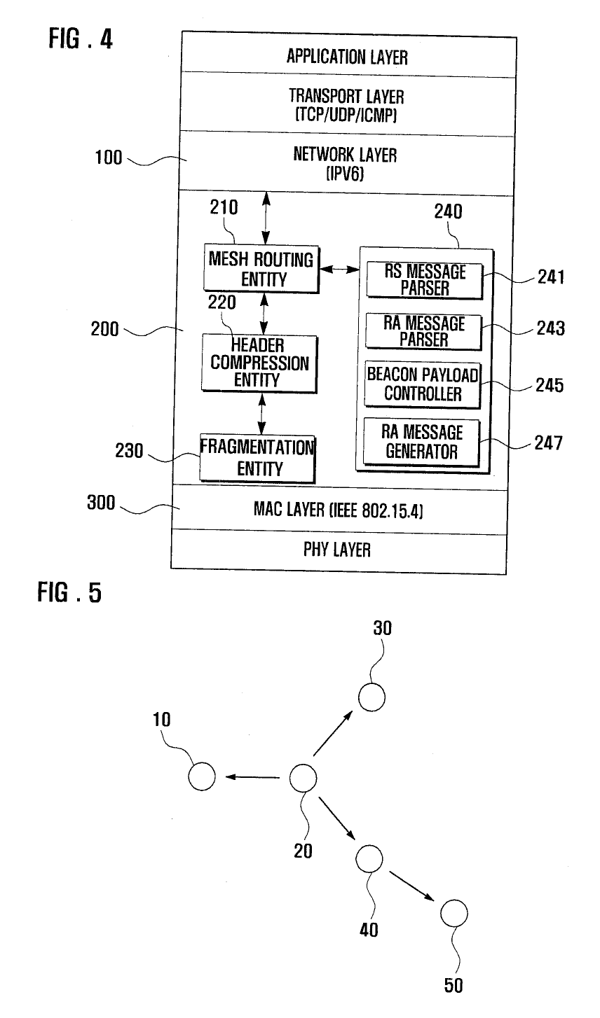

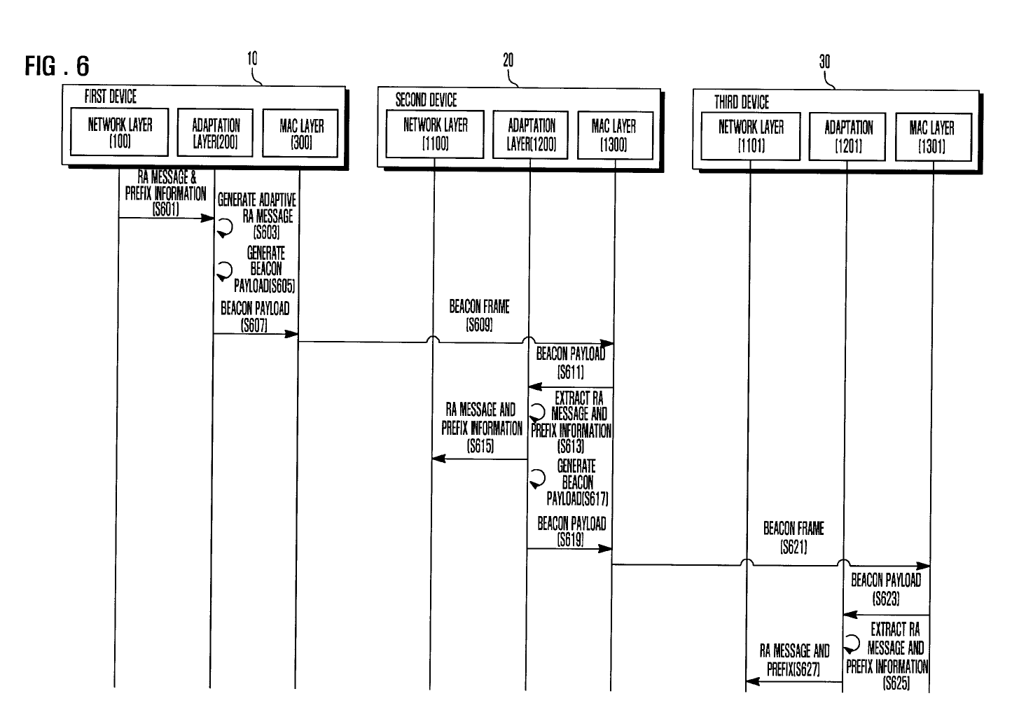

FIG. 5 is a schematic diagram illustrating a network topology of a 6LoWPAN according to an exemplary embodiment of the present invention, and FIG. 6 is a message flow diagram illustrating an address autoconfiguration method for the 6LoWPAN of FIG. 5 according to an exemplary embodiment of the present invention.

In the exemplary embodiment shown in FIG. 5, it is assumed that the first, second, and fourth devices 10, 20, and 40 are FFDs, and the third and fifth devices 30 and 50 are RFDs. Also, it is assumed that the first device 10 is a PAN coordinator, and the second and fourth devices 20 and 40 are coordinators.

FIG. 6 shows message flows among layers of the first device (PAN coordinator) 10, second device (link coordinator) 20, and third device (RFD) 30. In FIG. 6, the address prefix broadcasted by the PAN coordinator 10 is delivered to the RFD 30 via the link coordinator 20. The PAN coordinator 10 broadcasts the RA message periodically. With reference to the RA message, the devices constituting the 6LoWPAN 1000 configure their IP address automatically.

Referring now to FIG. 6, the network layer 100 of the first device (PAN coordinator) 10 sends an RA message and prefix information to the adaptation layer 200 (S601). The RA message and prefix information is formatted as shown in FIGS. 2B and 2C. Particularly, the prefix information includes a Prefix and a Prefix Length.

Upon receipt of the RA message and prefix information sent in (S601), the adaptation layer 200 of the first device 10 generates an adaptive RA message using the RA message and prefix information (S603) and generates a beacon payload containing the adaptive RA message (S605). Here, the adaptive RA message is generated by the RA message parser 243, and the beacon payload is generated by the beacon payload controller 245. At this time, the beacon payload is generated using a macBeaconPayloadAttribute.

The adaptation layer 200 of the first device 10 delivers the beacon payload containing the adaptive RA message to the MAC layer 300 (S607) of the first device. Upon receipt of the beacon payload, the MAC layer 300 of the first device 10 generates a beacon frame containing the beacon payload and broadcasts the beacon frame (S609). Here, the beacon payload carries the RA message containing a prefix.

If the second device 20 receives the beacon frame broadcasted by the first device 10, the MAC layer 1300 of the second device 20 extracts the beacon payload from the beacon frame and delivers the beacon payload to the adaptation layer 1200 (S611). The adaptation layer 1200 of the second device 20 extracts the RA message and prefix information from the adaptive RA message contained the beacon payload (S613) and delivers the RA message and prefix information to the network layer 1000 (S615). At this time, the adaptation layer 1200 activates a proxy entity 240 and the mesh routing entity 210, such that the RA message generator 247 extracts the RA message and prefix information, and a mesh routing entity 210 delivers the RA message and prefix information to the network layer 1000. That is, the RA message generator 247 extracts the adaptive RA message from the beacon payload and recovers the RA message and prefix information from the adaptive RA message. The RA message generator 247 also delivers the RA message and prefix information to the network layer 1000.

At this time, the second device 20 can auto-configure its IP address by adding the prefix contained in the prefix information to its MAC address.

The adaptation layer 1200 of the second device 20 generates a beacon payload containing the adaptive RA message (S617). The beacon payload is generated by the beacon payload controller 245 of the proxy entity 240. Here, the beacon payload identical with that extracted at step S613.

Next, the adaptation layer 200 of the second device 20 delivers the beacon payload to the MAC layer 1300 (S619), and the MAC layer 1300 generates a beacon frame containing the beacon payload and transmits the beacon frame to the third device 30 (S621).

Upon receipt of the beacon frame transmitted by the second device 20, the MAC layer 1301 of the third device 30 extracts the beacon payload carried by the beacon frame and delivers the beacon payload to the adaptation layer 1201 (S623). The adaptation layer 1201 of the third device 30 extracts the RA message and prefix information from the adaptive RA message contained in the payload and delivers the RA message and prefix information to the network layer 1001 (S625). At this time, the RA message generator 247 of the proxy entity 241 of the adaptation layer extracts the RA message and prefix information, and the mesh routing entity 210 delivers the RA message and prefix information to the network layer 1001. That is, the RA message generator 247 extracts the adaptive RA message from the beacon payload and recovers the RA message and prefix information from the adaptive RA message. Next, the RA message generator 247 delivers the RA message and prefix information to the network layer 1001 through the mesh routing entity 210 (S627)

Through the above-described procedure, the third device 30 obtains the prefix and configures its 6LoWPAN address using the prefix and its MAC address.

As described above, since the prefix which is used for address autoconfiguration is carried by the beacon frame, it is possible to avoid traffic flooding.

Although the address autoconfiguration procedure is described with an exemplary network topology in which the second device is a link coordinator, the present invention is not limited thereto. For example, there can be multiple link coordinators in a 6LoWPAN such that each of the link coordinators transmits its beacon frame carrying the prefix. Since the first, second, and fourth devices 10, 20, and 40 are sequentially broadcasting the beacon frame, the first to fifth devices 10 to 50 can obtain the prefix from the beacon frames, and each device can configure its IP address by adding the prefix to its MAC address.

In the address autoconfiguration method of the embodiment depicted in FIG. 6, the RFDs obtain the prefix from the RA message which is periodically transmitted by a PAN coordinator. Now, an address autoconfiguration method according to another exemplary embodiment, in which an RFD obtains the prefix by transmitting an RS message and receiving the RA message carrying the prefix in response to the RS message, is described.

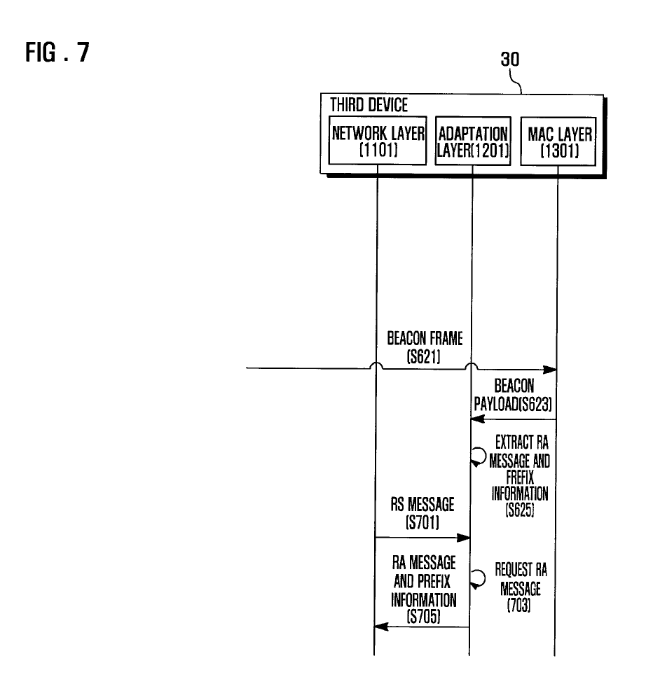

FIG. 7 is a message flow diagram illustrating an address autoconfiguration method for the 6LoWPAN of FIG. 5 according to another exemplary embodiment of the present invention.

In the exemplary embodiment, the third device 30 receives and temporarily stores a beacon frame. That is, the third device 30 obtains the prefix from the beacon frame (S621), extracts a beacon payload from the beacon frame (S623), and extracts an RA message and prefix information from an adaptive RA message carried by the beacon payload (S625).

In the exemplary embodiment shown in FIG. 7, when an IP configuration is required, the network layer 100 of the third device 30 generates an RS message and delivers the RS message to the adaptation layer 1201 (S701).

Upon receipt of the RS message, the adaptation layer 1201 activates the proxy entity 240 such that the RS message parser 241 requests the RA message generator 247 for the RA message (S703). In response to the RA message request, the RA message generator 247 delivers the RA message and prefix information to the network layer 1001. Here, the RA message and prefix is of being received and stored at step S625. Using the prefix and its MAC address, the third device 30 auto-configures its IP address.

Unlike the conventional 6LoWPAN address autoconfiguration method, the RFD has no need to transmit the RS message to the PAN coordinator, resulting in a reduction of network traffic.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims. As described above, the address autoconfiguration method and system propagates a prefix using beacon frames of a network coordinator and link coordinators, thereby avoiding traffic flooding. Also, the address autoconfiguration method and system enables devices to obtain a prefix without transmitting router solicitation (RS) message, thereby reducing dramatically network traffic, resulting in network throughput.

What is claimed is:

1. An address autoconfiguration method for an Internet Protocol (IP) based network including a plurality of devices, comprising:
(a) generating a first beacon frame by a first device containing an adaptive router advertisement (RA) message having prefix information;
(b) broadcasting the first beacon frame; and
(c) configuring an IP address by a second device receiving the first beacon frame broadcast in (b) and using the prefix information extracted from the adaptive RA message carried by the first beacon frame and a physical address of the second device.

2. The address autoconfiguration method of claim 1, further comprising:
(d) transmitting a second beacon frame carrying the adaptive RA message by the second device; and
(e) configuring an IP address, at a third device receiving the second beacon frame using the prefix information extracted from the adaptive RA message carried by the second beacon frame and a physical address of the third device.

3. The address autoconfiguration method of claim 2, wherein the adaptive RA message comprises an RA message and the prefix information.

4. The address autoconfiguration method of claim 1, wherein the prefix information includes a type field, a length field, a prefix length field, an L flag field, an A flag field, a valid lifetime field, a preferred lifetime field, and a prefix field.

5. The address autoconfiguration method of claim 2, wherein the first and second devices comprise full function devices (FFDs) having routing functionality, and the third device comprises a reduced function device (RFD) having no routing functionality.

6. The address autoconfiguration method of claim 2, wherein the first device comprises a network coordinator and the second device comprises a link coordinator.

7. The address autoconfiguration method of claim 1, further comprising:
(d) transmitting a second beacon frame carrying the adaptive RA message by the second device;
(e) extracting the second beacon frame received by a third device, wherein the prefix information from the adaptive RA message of the second device is carried by the second beacon frame; and
(f) configuring an IP address of the third device using the prefix information and a physical address of the third device.

8. The method according to claim 7, wherein the third device obtains the prefix information and configures its 6LoWPAN address using the prefix and its MAC address.

9. The method according to claim 1, wherein the RA message includes a type field, a length field, a cur hop limit field, an M flag field, an O flag field, a reachable timer field, a retrans timer field, and an option field.

10. The method according to claim 9, wherein the prefix information of is contained in the option field of the RA message.

11. An address autoconfiguration system for an Internet Protocol (IP) based network including a plurality of devices, comprising:
a first type device for broadcasting a first beacon frame carrying a prefix;
at least one second type device for relaying the prefix using a second beacon frame; and
at least one terminal device for configuring an IP address using the prefix carried by the second beacon frame and a physical address of the terminal device.

12. The address autoconfiguration system of claim 11, wherein the at least one second type device configures an IP address using the prefix and a physical address of the second type device.

13. The address autoconfiguration system of claim 12, wherein each device comprises:
a network layer for routing an adaptive router advertisement (RA) message containing a prefix;
an adaptation layer for generating a beacon payload containing the adaptive RA message; and
a media access control layer for generating a beacon frame containing the beacon payload to be transmitted and extracting the beacon payload from a received beacon frame.

14. The address autoconfiguration system of claim 13, wherein the MAC layer extracts the beacon payload from the received beacon frame and delivers the beacon payload to the adaptation layer.

15. The address autoconfiguration system of claim 14, wherein the adaptation layer extracts the adaptive RA message from the beacon payload and extracts an RA message and the prefix.

16. The address autoconfiguration system of claim 15, wherein the adaptation layer comprises:
an RA message generator for generating the adaptive RA message;
a beacon payload controller for generating the beacon payload containing the adaptive RA message and delivering the beacon payload to the media access control layer;
an RA message parser for extracting an RA message and prefix from a beacon payload received from the media access control layer; and
an RS message parser for receiving a router solicitation (RS) message from the media access control layer and outputting the RA message and prefix corresponding to the RS message to the RA message generator.

17. The address autoconfiguration system of claim 12, wherein the first and second type devices comprise full function devices (FFDs), and the at least one terminal device comprises a reduced function device (RFD).

18. The address autoconfiguration system of claim 12, wherein the first type device comprises a network coordinator, and the at least one second type device comprises a link coordinator.

19. The address autoconfiguration system of claim 12, wherein the RA message includes a type field, a length field, a cur hop limit field, an M flag field, an O flag field, a reachable timer field, a retrans timer field, and an option field.

20. The address autoconfiguration system of claim 19, wherein the prefix information of is contained in the option field of the RA message.
